(19) United States
(12) Patent Application Publication
(10) Pub. No.: US 2017/0041264 A1
(43) Pub. Date: Feb. 9, 2017

(54) SYSTEM AND METHOD FOR CONTROLLING DATA TRANSMISSIONS USING HUMAN STATE-BASED DATA

(71) Applicant: Sensaura Inc., Montreal (CA)

(72) Inventors: Mojtaba KHOMAMI ABADI, Montreal (CA); Fahd BENCHEKROUN, Montreal (CA)

(73) Assignee: Sensaura Inc., Montreal (CA)

(21) Appl. No.: 15/230,252

(22) Filed: Aug. 5, 2016

Related U.S. Application Data
(60) Provisional application No. 62/202,492, filed on Aug. 7, 2015.

(51) Int. Cl. H04L 12/58; H04L 29/08

(52) U.S. Cl. CPC H04L 51/12; H04L 67/306

(57) ABSTRACT

A system and method are provided to control the transmission of data based at least in part on a detected or sensed human state (e.g., emotion) of the user. Personal data of a user may be detected by a sensor of the system. Human state information may be determined based on the personal data. Human state information may be used to control transmission of an intended data transmission of the user. The user may be notified of data transmission control. The system may further user complementary information to determine to control data transmission.

### RELATED APPLICATIONS

This application claims the benefit of U.S. Provisional Application Ser. No. 62/202,492, filed Aug. 7, 2015, entitled “SYSTEM AND METHOD FOR CONTROLLING DATA TRANSMISSIONS USING HUMAN STATE-BASED DATA,” which is incorporated by reference herein.

### TECHNICAL FIELD

The following disclosure relates to systems and methods for controlling data transmissions using human state-based data.

### BACKGROUND

Modern mobile communication capabilities, such as email and texting, for example, have made communications easier and faster. Users can respond instantaneously, sometimes faster than rational thinking can intervene, letting impulses and emotions take over. Unfortunately, written words, unlike spoken words, can become permanent, typically do not disappear into the air, and transmissions are typically irreversible if the data transmission is not dropped by the communications infrastructure. Even if a user regrets the transmission once the responsible emotion fades, there is often nothing that can be done to reverse the action.

Some mobile applications have been created to deal with specific scenarios. For example, “Drunk Lock” is an application that will ask the user math questions to prevent such users from sending texts or other types of messages when thinking is impaired by alcohol. There are also solutions that hold e-mails before sending them, to give the user time to think about the message, and may provide the option to cancel or change the message.

Another example that lets you change the course of the action after the transmission is sent is “ ”. The application lets you cancel the transmission in the time allowed that the user defines (e.g. 5, 10, 20, 30 seconds).

“On Second Thought” is also an app that lets you retrieve sms messages after clicking on the send button but before they are actually sent. It has also the “curfew” option that will disable any transmission after the “curfew” time set by the user.

Such conventional solutions are limited in their applicability, offering a user control in limited situations and in limited ways. These conventional Unsend situations lack flexibility, context awareness, and autonomy, among other drawbacks. Systems and methods disclosed herein address these and other drawbacks of conventional transmission control solutions.

### SUMMARY

The following provides a system and method to control transmission of data based on one or more of a detected human state such as a sensed emotion, mood, etc., of the user, a relationship between a user and an intended recipient, a context of an intended message, pre-defined rules of a user, content of an intended message, and other parameters. Once a triggering state is recognized while opening a data transmission application, the transmission action may trigger a notification allowing the user to interrupt the transmission, continue as intended, or any other suitable predetermined or user-defined action. Triggering states may include states corresponding to emotions, moods, mental state, drunkenness, and other contexts that may alter the sending capacity of the user. Triggering states may further include any detectable state or modality selected and defined by the user as a triggering state. In some implementations, triggering states may be measured by severity, for example, including a degree of emotion experienced by the user.

In an embodiment, a system for controlling data transmissions based on a human state of a user is provided. The system may include at least one sensor configured to recognize personal data of the user indicative of the human state of the user, at least one memory module, a communications interface, and a computer system comprising one or more physical processors programmed by computer program instructions. When executed, the computer program instructions may cause the computer system to receive personal data of the user from the at least one sensor, determine human state information according to the first personal data, receive communication data intended composed by the user and intended for transmission, identify complementary information based on the received communication data, access the at least one memory module to obtain at least one trigger evaluation rule, and control transmission of the communication data via the communications interface according to the human state information and the complementary information. In another embodiment, a method for controlling data transmissions based on a human state of a user is provided. The method may include recognizing, via at least one sensor, personal data of the user indicative of the human state of the user. Receiving, by a computer system comprising one or more physical processors programmed by computer program instructions, personal data of the user from the at least one sensor, determining, by the computer system, human state information according to the first personal data, receiving, by the computer system, communication data intended composed by the user and intended for transmission, identifying, by the computer system, complementary information based on the received communication data, accessing, by the computer system, at least one memory module to obtain at least one trigger evaluation rule, controlling, by the computer system, transmission of the communication data via a communications interface according to the human state information and the complementary information.

### BRIEF DESCRIPTION OF THE DRAWINGS

Exemplary embodiments are described with reference to the appended drawings wherein:

FIG. 1 is a schematic diagram of an exemplary system for controlling data transmissions using human-state data;

FIG. 2 is a block diagram illustrating an example of a configuration for a personal device able to control data transmissions using human-state data;

FIG. 3(a) is a block diagram illustrating an exemplary configuration for implementing an human-state recognition system;

FIG. 3(b) is a block diagram illustrating an exemplary configuration for implementing an human-state recognition system;

FIG. 3(c) diagram illustrating an exemplary configuration for implementing an human-state recognition system;

FIG. 4 is an exemplary screen shot of an interrupted transmission notification based on human emotional state;

FIG. 5 is an exemplary screen shot of a blocked transmission notification based on human emotional state;

FIG. 6 is a flow chart illustrating an exemplary method, implementable by computer executable instructions, for controlling data transmissions using human-state data where the essential modules are presented in a unified schema;

FIG. 7 is a diagram illustrating an exemplary set of modules involving computer executable instructions for controlling data transmissions using human-state data and other information sources where essential and optional modules are put in a unified framework;

FIG. 8 is a diagram illustrating an exemplary set of modules involved in taking the control decision during the data transmission process given the human state; and

FIG. 9 is a diagram illustrating an exemplary set of modules involved in taking the control decision during the data transmission process given the human state and other information sources.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10, any component of or related thereto, etc., or accessible or connectable thereto. Any application or module herein described may be implemented using computer readable/executable instructions that may be stored or otherwise held by such computer readable media.

The system described herein relates to methods, services, and apparatuses for controlling data transmissions based on human state information and other information, including message content, intended recipient, user context and history, user rules, and other suitable information.

As used herein, human state refers to the cognitive and/or physical state of human subjects. Human cognitive state refers to the state of a person's cognitive processes that defines his/her state of mind. This may include, but is not limited to (i) emotions, mood and interestedness (ii) amnesia, memory loss, blackout i.e. partial or total loss of memory; (iii) paramnesia (a disorder of memory in which dreams or fantasies are confused with reality), (iv) readiness or set (being temporarily ready to respond in a particular way) (v) consciousness, (vi) confusion, i.e., a mental state characterized by a lack of clear and organized thought process and behavior, (vii) certainty, (viii) uncertainty or doubt, (ix) preoccupancy, preoccupation, engrossment, or absorption, i.e., the mental state of being preoccupied by something, (x) inwardness, i.e., the preoccupation with one's one attitudes and ethical or ideological values; (xi) outwardness, i.e., the concern with outward things or material objects as opposed to the mind and spirit, and (xii) morbidity, i.e., an abnormally gloomy or unhealthy state of mind.

Human physical state refers to a set of human body configurations that determine a concept, activity and/or a behavior. The set may have temporal variation so that it involves changes in body (limbs) responses over time that determine a certain concept, activity and/or a behavior of the person. Activity may refer to what a person is doing or interacting with (i) in a daily basis, (ii) as a task, (iii) in physical organized activities. The concept and behavior could refer to the physical or mental health of a person, e.g. (i) abnormal gait patterns that relate to central nervous system disorders, (ii) medication ingestion impacts, (iii) a person being physically damaged, (iv) a person being drunk or under the impact of using drugs, (iv) a person committing to a crime or serial killer behavior (v) a person committing to security related abnormal behavior, (vi) a person committing to abnormal social behaviors and/or violent activities due to socio-psychological disorders.

Human state information may be collected by one or more modalities. As used herein, modalities refer to sources of input information. Different modalities may collect information via different hardware (e.g., sensors, cameras, etc.) based on different measureable quantities. A modality may refer to an input source of information for a system from which to perform a certain process to provide a useful output (processed) information, and/or make a decision. Therefore, modalities may be any source of raw and/or processed information. A modality may thus refer to (i) a sensor device that senses a set of information to make available the sensed information to the system or (ii) a set of information channels that is available as input information for the system. In the latter case, most often, the set of information channels are provided by other systems and they are the output of other systems. For instance, in a system for emotion recognition from physiological signals, an ECG sensor could be considered as a modality as it senses the electrocardiography signal of the user and provides it as a source (input) of information to the processing system.

Various Modalities may have overlap of information content so that they may induce some degrees of redundancies when they are made available to the systems at the same time. However, such overlapping modalities may also have complementary information to assist the system with its information processing. In case two modalities have exactly the same information content to a system, they may be used only to make the system noise tolerant (i.e. when one channel gets noisy and the other does not). For instance heart-rate measured from right wrist blood volume pulse (BVP) and left wrist BVP may be considered the same. However, do to subject movement, signal to noise ratio between the two may vary.

Data transmission control may refer to any action that alters a standard course of sending a data transmission after a user elects to send the data transmission. Data transmission control may include, without limitation, stopping transmission, delaying transmission, rerouting transmission, pausing transmission and/or any other option that would change the normal course of the action. Controlled data transmissions may include e-mails, text messages, photos (as attachments or file transfers), videos (as attachments or file transfers), credentials (as part of access request), social media messages, and any other media or data from a device, mobile or not, to another. Methods and systems described herein may be applied as soon as a data transmission software or application has access to the user's state.

Data transmission control may further include messages to the user about actions taken and a state of the user in conjunction with delaying, stopping, pausing, and/or rerouting transmissions. Data transmission control may further include offering alternative options to a user to proceed with transmission, including, for example, cancelling, editing, and/or saving a message or data.

Data transmissions may be advantageously controlled to address the above-noted problems, by providing a data transmission control system that bases decisions on the human-state of the user, and which may be implemented in real-time.

The system described herein may be implemented in various applications, some examples of which are provided below, without limitation.

The following examples refer to, for illustrative purposes, controlling data transmissions according to a detected emotion, however, it will be appreciated that these principles equally apply to any human state that is detectable and warrants intervention, for example, moods, activities, mental state and other detectable circumstances. The human state may be detected using any modality, including sensors, algorithms, systems or other detection methods and the examples provided herein refer to the use of sensors for illustrative purposes only.

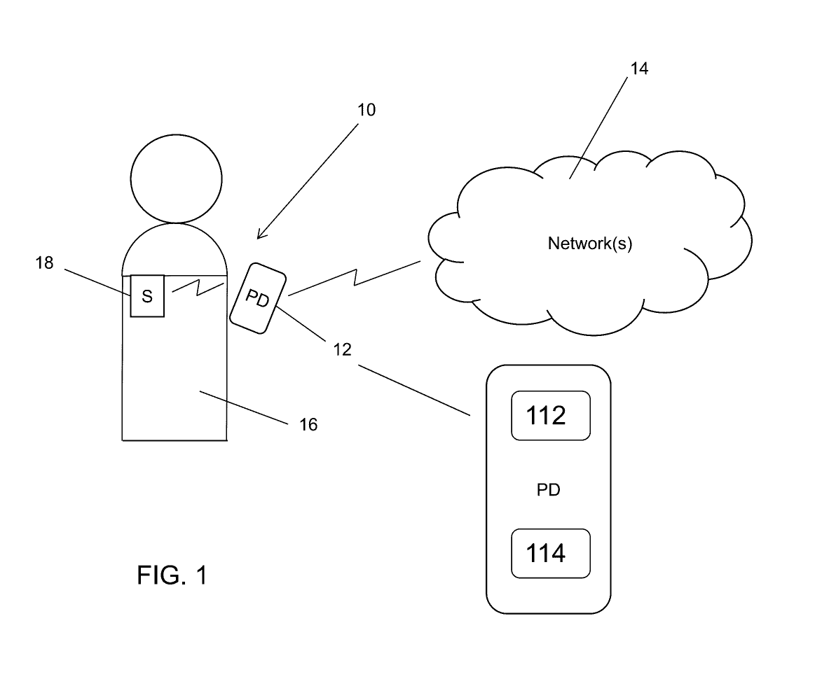

Turning now to the figures, FIG. 1 illustrates an exemplary system for controlling data transmissions using human-state data, hereinafter referred to as the “system 10”. The system 10 may be configured to control data transmissions from a personal device (PD) 12 to other users or entities, e.g., via a network 14 as shown in FIG. 1. While the personal device 12 shown in FIG. 1 resembles a mobile or handheld device such as a smartphone, it will be appreciated that the following principles apply to any electronic device with data communication or transfer capabilities, such as a personal computer (PC), laptop, tablet, gaming device, embedded system (e.g. in-vehicle), etc. In alternative embodiments, aspects of the system may be implemented via cloud based computing resources.

Personal device 12 may include one or more physical processors 112 (also interchangeably referred to herein as processors 112, processor(s) 112, or processor 112 for convenience), one or more storage devices 114, and/or other components. Processors 112 may be programmed by one or more computer program instructions.

The system 10 may include at least one sensor 18 or equivalent data acquisition device, detection method, or “modality” in general, which is capable of detecting or sensing physiological, environmental, subjective and/or contextual data related to or associated with a user 16 and/or his/her environment. Such data may collectively be referred to herein as personal data. Such personal data may be indicative of, or may otherwise be correlated to a human state, for example, but not limited to, an emotion, as described in the following examples, of user 16. For example, a recognition system may be used to sense or detect speech, gesture, posture, brain signals, heart signals, muscle activities, blood factors, skin electro-dermal signal, facial activities, respiration patterns, body limbs movement, joints movement, or any other suitable physiological or physical feature, biofeedback, word/speech analysis, change, trait, or event. As will be discussed below, the sensor(s) 18 may be used to acquire personal data that may be used by the recognition capabilities of the system 10 to evaluate human state of the user 16 for determining whether or not to notify the user 16 prior to proceeding with a data transmission.

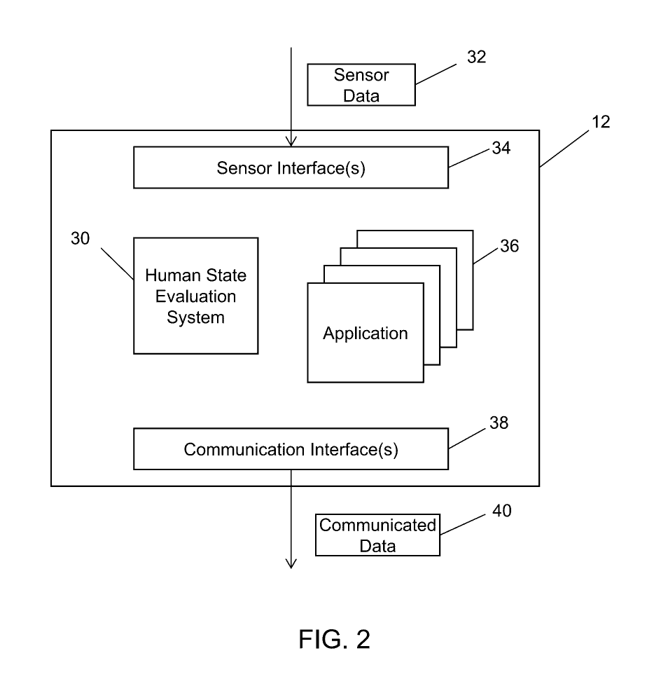

FIG. 2 illustrates an example of a configuration for a personal device 12 that includes an ability to control data transmissions using human-state data. Device 12 may include at least one sensor interface 34, at least on communications interface 38, and one or more software modules, including human state evaluation system 32 and applications 36. Human state evaluation system 30 and applications 36 may be implemented by executable computer instructions executed by at least one physical processor 112. The device 12 receives sensor data 32 from the at least one sensor 18, e.g., personal data that has been processed to indicate a human state and/or personal data that may be processed by the device 12 to determine a human state. As such, it may be appreciated that the sensor data 32 can include raw data, processed data, in any suitable format that is readable and understandable to the device 12. The sensor data 32 may be received using one or more sensor interfaces 34, which may include any available data input or port, e.g., Bluetooth, WiFi, USB, etc. Device 12 may include computer program instructions to implement one or more applications 36 capable of sending communicated data 40 via one or more communication interfaces 38 as a data transmission. Communication interfaces 38 may be physical hardware components of personal device 12 capable of transmitting data wirelessly or in a wired manner. Communications interfaces 38 may include any type of transmitting and/or receiving device, including, but not limited to, WiFi antennas, Bluetooth antennas, Cellular antennas, wired connections, etc. For example, an email or other communication application 36 may be used to compose and send an email to another user via communications interface 38. At least one application 36 may be coupled to or otherwise in communication with a human state evaluation system 30 capable of using sensor data 32 to determine whether or not a current human state is a triggering state (as explained below). If the current human state is a triggering State, communicated data 40 is a candidate for intervention prior to transmission via communications interface 38, such as by triggering a notification or blocking a transmission.

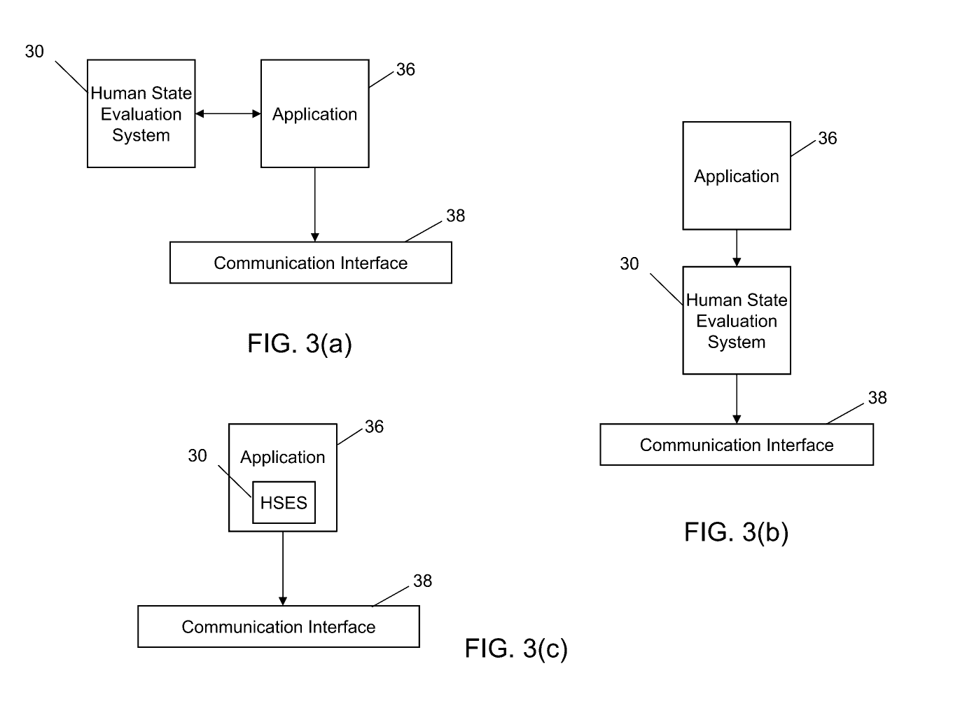

FIGS. 3(a) through 3(c) illustrate exemplary configurations that enable communication data 40 output by an application 36 to be controlled by the human state evaluation system 30. In FIG. 3(a) the human state evaluation system 30 operates alongside the application(s) 36 and has at least one interface or communication path over which the application 36 may be monitored or may share information with the human state evaluation system 30. For example, the application 36 may provide an alert or notification of a message being composed that may be detected by the human state evaluation system 30.

In FIG. 3(b) human state evaluation system 30 is situated along the communication path from the application 36 to the communication interface 38. In this way, human state evaluation system 30 may act as a transparent interceptor that may either intervene or decide to take no action and allow communicated data 40 to be sent via communication interface 38 without the user being aware of the interception.

In FIG. 3(c), human state evaluation system 30 is configured as a sub-module or is otherwise programmed into the application 36 as a routine or object that performs the functionality herein described. It may be appreciated that the configurations shown in FIGS. 3(a)-3(c) are illustrative only and other configurations are possible within the principles discussed herein.

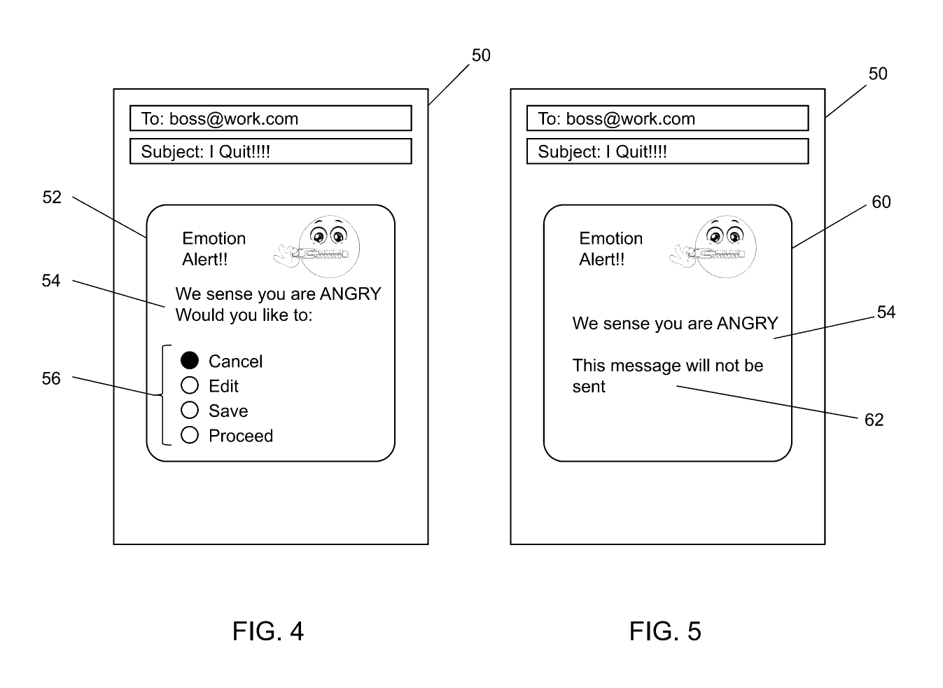

As discussed above, in an exemplary implementation, human state evaluation system 30 may control, e.g., stop or delay, a data transmission by displaying a notification to the user. FIG. 4 illustrates an exemplary message composition screen shot 50 in which a user indicates by message to a superior that they wish to quit their job. By detecting a triggering state, in this case, anger, human state evaluation system 30 may initiate the display of an emotion alert 52 prior to allowing the composed message to be sent. In this example, emotion alert 52 includes a notification 54 explaining what is the triggering state and the nature of the alert 52, as well as a set of options 56 for continuing, e.g., cancel, edit, save, proceed. It may be appreciated that these options 56 are for illustrative purposes only.

FIG. 5 illustrates an example of another alert 60 which includes a similar notification 54 as shown in FIG. 4 but also indicates that the message will not be sent with an action alert 62. In this example, the human state evaluation system 30 is programmed to block messages for certain triggering states or ranges of human (emotional) states (e.g., by using thresholds or set points). For example, a particularly high heart rate outside of an elevated range could be correlated to extreme anger or stress, at which point the options 56 are omitted in favor of the action alert 62 shown in FIG. 5.

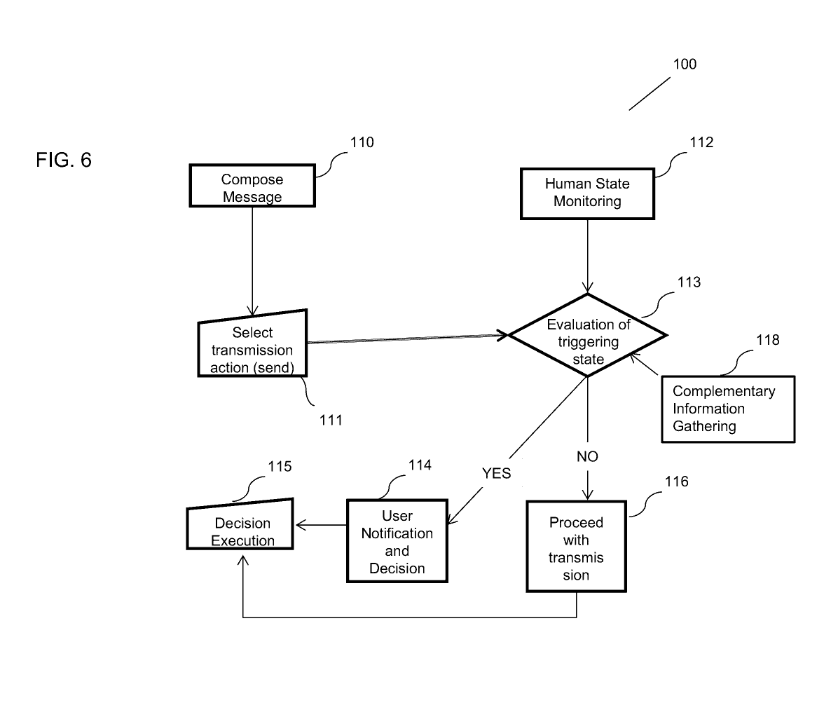

FIG. 6 is an exemplary flowchart illustrating a method implementable by computer executable instructions for human-state controlled data transmission. FIG. 6 illustrates an exemplary human-state controlled data transmission program 100, that may be performed by human state evaluation system 30 to control data transmissions based on human state data. In an operation 110, a data transmission application 36 (e.g., text message application, social media application, Facebook, Twitter, Snapchat, E-mail, etc.) may be used to compose a message and/or initiate a data transfer.

In an operation 111, data transmission application 36 may initiate a data transmission action. The communicated data 40 composed by user 16 at step 110 may be selected for data transmission. Data transmission may include posting, e-mailing, sending, and any other action in an application 36 that initiates a data transfer.

In an operation 112, a human state may be monitored by a human state recognition unit 172 (HSRU). Human state monitoring may occur continuously and/or may be initiated in response to user action, e.g., switching on a personal device 12, the composition of a message at operation 110, the decision to send a message at operation 111, and/or any other suitable time to initiate human state monitoring. Human state evaluation system 30 may act to monitor a human state of user 16 via the one or more sensors 18 associated with system 10, and/or via any other data modality that is available.

In an operation 113, human state evaluation system 30 may evaluate whether or not the currently detected human state (e.g., as determined in operation 112), constitutes a triggering state requiring intervention. Optionally, human state evaluation system 30 may determine an extent of intervention required. Optionally, an extent of intervention may be based on a degree of triggering state experienced. Human state evaluation system 30 may employ an intelligent evaluation system 133 (discussed in greater detail below) to determine and/or evaluate a triggering state of a user.

A human state may constitute a triggering state if the human state is such that it alters a user's normal capacity and/or ability to compose, evaluate, and send data transmissions. Some triggering states, for example, extreme anger, may be determined by system 10 to require intervention. Other triggering states, for example, moderate or slight anger, may be determined by system 10 to not require intervention.

If no triggering state requiring intervention is detected, data transmission may proceed in an operation 116. Data transmission application 36 may proceed with data transmission. In some implementations, data transmission may proceed without the user knowing about the human state evaluation performed at operation 113.

If, however, operation 113 detects a triggering state requiring intervention, a notification may be provided to a user at operation 114. Operation 114 may further provide an opportunity for a user to decide how or whether to proceed with a data transmission. Notification and decision operation 114 may be performed by notification unit 174. Operation 114 may further permit system 10 to automatically decide how or whether to proceed with a data transmission. User notification at operation 114 may be provided, for example, using a display as shown in the screen shots 50 in FIGS. 4 and 5, using an alarm or vibration, and/or any other means of notification that personal device 12 is capable of. Notification operation 114 may provide a user with options for proceeding, for example, saving a message for later, cancelling a transmission, rerouting a transmission to a different location, and others. Notification operation 114 may act without providing any user options, for example by automatically delaying or cancelling a data transmission. Notification operation 114 may provide a user with opt-in and/or opt-out warnings, for example, alerting the user that a message will not be sent without an affirmative choice or that a message will be sent after a certain delay unless the user actively cancels it. A decision of whether to provide a user with options and/or to block a message entirely may be based on a severity of a triggering state determined at operation 113. Very severe triggering states may result in a decision to block a message entirely, while moderate triggering states may result in a decision to present a user with options.

In an operation 115, a user selected or automatically selected decision of whether and how to proceed with a data transmission may be executed by application 36 or human state evaluation system 30.

Human states may be potentially troublesome due to potential repercussions caused by message content. Upon detection of potentially troublesome data content (i.e., based on evaluation of the human state), the user may be provided with a notification that they may wish to reconsider or review the transmission/data before sending. Even if a user should choose to continue, the notification may only require one additional step for continuing with the data transmission. If a human state is not a triggering state (i.e. it is not evaluated as troublesome and hence it does not cause an intervention), then this determination may be transparent to the user and they do not need to know about the “behind the scenes” evaluation.

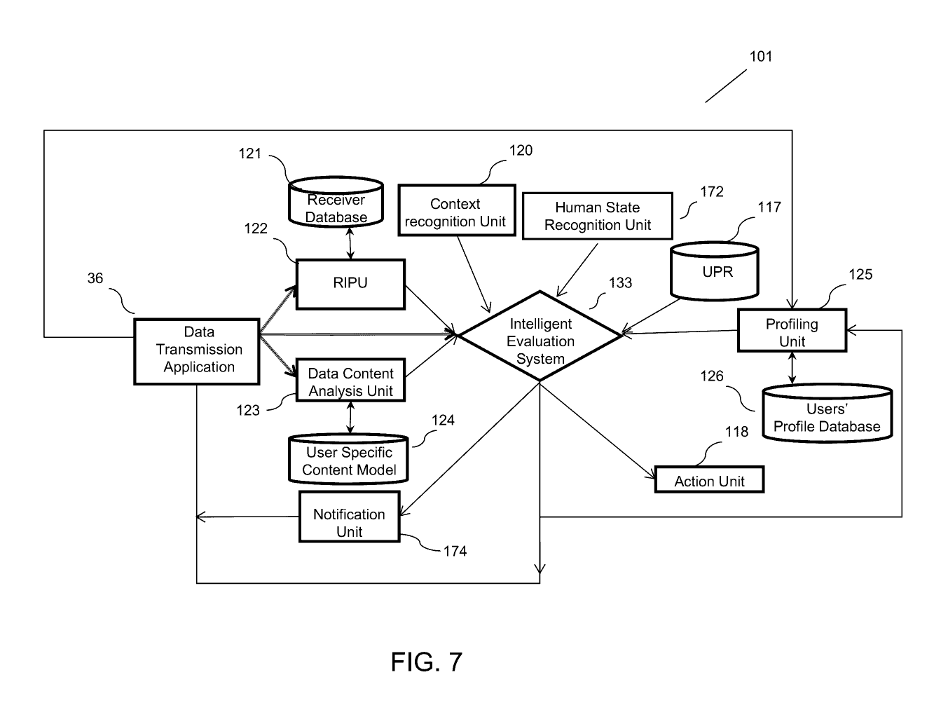

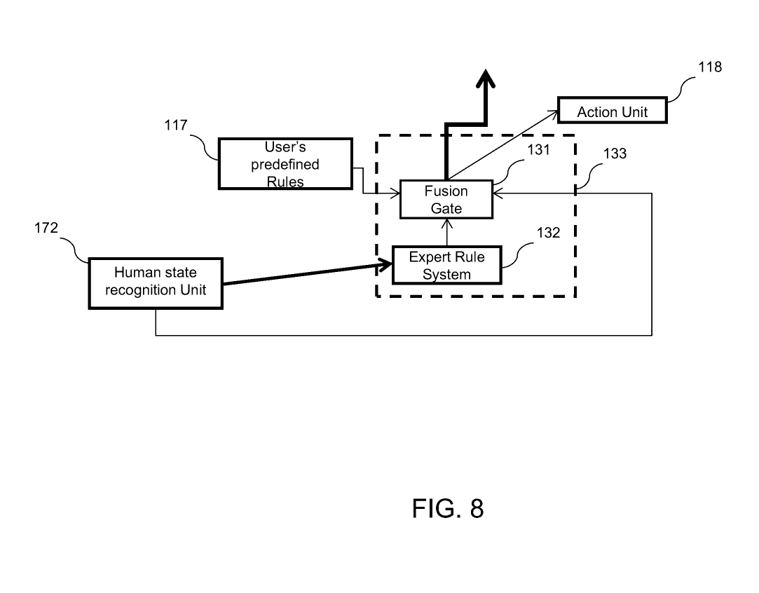

Evaluation of triggering states at operation 113 may be performed with the help of a set of trigger evaluation rules embedded-in and/or created-with an intelligent evaluation system (IES) 133. Trigger evaluation rules may be considered as a map from inputs to possible triggers and may be either be defined by a human and/or be learned with the help of an artificial intelligence method and/or algorithm e.g. using a machine-learning algorithm or with a fuzzy inference system. The trigger evaluation rules may be employed to assess the human state together with other optional complementary information so that the decision for triggering an intervention is taken accordingly. An instance of a rule is the following: “If the human state is equal to emotionally highly angry then trigger an intervention accordingly”. The trigger evaluation rules may be pre-determined by the developers (as default settings for instance) of the IES 133 and/or may be adjusted by the user 16. The output of the Intelligent Evaluation System 133 (as illustrated in FIG. 7 and FIG. 8 and explained below) may optionally involve triggering an Action Unit 118 where a notification can be sent to a pre-determined agent and/or a third party system may be triggered. Trigger evaluation rules may be stored in memory module 114, and/or in a cloud based memory storage device and may be accessed by IES 133.

In some implementations, IES 133 may additionally use complementary information in a trigger state evaluation operation 113. In an operation 118, complementary information may be obtained by components of human state evaluation system 30 and provided to IES 133 for use in trigger state evaluation operation 113. Components for the collection of complementary information and data are described in greater detail below with respect to FIG. 7.

Complementary information may include additional information about the user, the communicated data 40, an intended recipient of the communicated data 40, a situation of the user, and a history of the user. Complementary information may include, for example, relationship information about a relationship between the user and the intended recipient, content data about message content, context data about a location, time, environment, or other situation in which the user is in, and user profile information about past user interaction with system 10.

FIG. 7 illustrates modules of an exemplary comprehensive system 101 implementable by a physical processor executing computer instructions for controlling data transmissions based on human state information and complementary information.

Comprehensive system 101 includes optional complementary steps and sources that may achieve better data transmission control results by using complementary information.

Comprehensive system 101 includes additional components that may provide more relevant information to be evaluated by IES 133.

Human state recognition unit 172 may perform human state recognition of user 16. Human state recognition unit 172 may obtain personal information via at least one sensor 18 and/or via any other available modality. Human state recognition system 172 may determine human state information according to the personal information obtained. As illustrated in FIG. 7, human state recognition system 172 may transfer human state information to intelligent information system 133.

Receiver's Information Processing Unit (RIPU) 122 may track information of the target receiver and provide the processed information to the IES 133. RIPU 122 may include a storage/memory component Receiver Database 121, to help the process in RIPU 122. Receiver database 121 may store information about a relation between the sender (i.e. the user 16) and the receiver(s) of a data transmission. The receiver of a data transmission may include a specific contact and/or a specific social media medium (e.g., Twitter, Instagram, Facebook, etc.) Receiver database 121 may be stored in memory module 114, and/or in a cloud based memory storage device. As illustrated in FIG. 7, RIPU 122 may receive data from data transmission application 36 (e.g., communicated data 40) and may provide data to IES 133.

Data Content Analysis Unit (DCAU) 123 may process and evaluate the content of communicated data 40. DCAU 123 may evaluate communicated data 40 according to its relevance to the evaluation of the human state and possible consequential decisions and/or actions. DCAU 123 may include a storage/memory component storing a user specific content model 124. User-specific content model 124 may be used by DCAU 123 to better process content provided by the specific user 16. User specific content model 124 may be stored in memory module 114, and/or in a cloud based memory storage device. As illustrated in FIG. 7, DCAU 123 may receive data from data transmission application 36 (e.g., communicated data 40) and may provide data to IES 133.

Context Recognition Unit (CRU) 120 may include an intelligent system configured to evaluate contextual parameters potentially relevant to the evaluation process within IES 113. As illustrated in FIG. 7, CRU 120 may provide data to IES 133.

User's Predefined Rules (UPR) 117 may include a set of information units and rules provided by the user 16. Each information unit or rule may describe conditions, selected by user 16 to be considered by the IES 133 in the evaluation process before triggering interventions on data transmission, given a certain human state (and an available set of relevant information). UPR 117 may be stored in memory module 114, and/or in a cloud based memory storage device. As illustrated in FIG. 7, UPR 117 may provide data to IES 133.

Profiling Unit (PU) 125 may be a system to create user-specific profiles and have access to the interaction (e.g. choices made at a user notification and decision operation 114) of user 16 with the human state evaluation system 30. PU 125 may record instances of interaction to be used in IES 133 and may learn from user 16 interactions over time. The PU 125 may include a memory component (e.g. a database), users' profile database (UPD) 126, where the information of the user may be stored. Part of the information that is useful for enhancing the evaluation of human state may be optionally accessible by other instances of Comprehensive system 101 running on other personal devices 12 of the user 16 and/or other users. UPD 126 may be stored in memory module 114, and/or in a cloud based memory storage device. As illustrated in FIG. 7, UPD 126 may receive data from data transmission application 36 (e.g., communicated data 40) and may provide data to IES 133.

Action Unit (AU) 118 may be configured to trigger an action external to the computer system. Triggering such an external action may include launching an agent and or application within personal device 12 and/or external to personal device 12. In some implementations, action unit 118 may be configured to communicate with another system e.g. an application or a device. As illustrated in FIG. 7, AU 118 may be activated by IES 133.

IES 133 may perform a trigger evaluation operation 113. Based on any combination of human state information received from HSRU 172, receiver's information that is received from RIPU 122, contextual information received from CRU 120, user-specific rules received from UPR 117, a user profile received from PU 125, and communicated data 40 content information received from DCAU 124, IES 133 may evaluate whether the human state of a user at the time they attempt to send a data transmission coupled with the relevant complementary information, indicates a triggering state requiring interventional data transmission control. IES 133 may evaluate a level or degree of a triggering state, and may determine that a level or degree surpasses an intervention threshold. In some implementations, an intervention may be adjusted according to a degree of a user's triggering state. IES 133 may adjust a user's evaluated triggering state up or down based on complementary information, as discussed in detail below. If IES 133 makes a determination that a user is not in a triggering state, IES 133 may communicate this information to data transmission application 36 to proceed with data transmission. If IES 133 makes a determination that a user is in a triggering state requiring intervention, IES 133 may communicate this information, as a well as a degree of intervention required, to notification unit 174.

A trigger evaluation operation 113 performed by IES 133 may be improved by taking into the consideration complementary data. Complementary data may include relationship information about a relationship between the receiver of communicated data 40 and user 16. The Receiver's Information Processing Unit (RIPU) 122 may provide relationship information to IES 133 to enhance a determination of whether a triggering exists. Some relationships between a user and a received may be considered highly sensitive, including relationships with family, co-workers, colleagues, professional relations, social relations, and superiors, for example. One example of sensitive relationship information may be a relationship between a user 16 and his or her workplace superior. IES 133 may use this information to determine a triggering state, for example, by considering a combination of sensitive relationship information and an angry human state to be a triggering state where a similar angry human state and non-sensitive relationship information would not be considered a triggering state. Thus, a data transmission between an angry user and his boss may be subject to transmission control, while a data transmission between the same angry user and his best friend may not be subject to such control.

RIPU 122 may access Receiver Database 121, to track and/or record the relation of the receiver(s) of a data transmission with user 16 and optionally the relevance and/or sensitivity of the relationship to the evaluation of the human state. The relations of the user with the potential receivers (e.g. contact list) of a data transmission and their importance level may be set by the user, may be provided by a third party system to the RIPU 122, and/or may be determined over time by RIPU 122.

A trigger evaluation operation 113 performed by IES 133 may be improved by evaluation of the content of the communicated data 40. Content of communicated data 40 may provide additional complementary information. DCAU 123 may be configured to perform such a content analysis. In some implementations, human state may be directly inferred from the content of communicated data 40. For example, the use of emoticons may directly convey human state—e.g., user emotion and/or mood. In another example, choice of language (e.g., swear words) and punctuation (e.g., all capital letters) may directly convey human state—e.g., user emotion and/or mood. As an instance of how the content of communicated data 40 may be useful for the IES 133, when user 16 is under anger human emotional state and is sending an email with troublesome content (e.g. including angry words) to his superior, then the IES 133 may determine a triggering state and trigger an intervention. However, if the content of the email is not troublesome, even if the user is determined to be angry by human state recognition unit 172, then the IES 133 may determine that no triggering state requiring intervention exists and avoid triggering an unnecessary intervention. The output of DCAU 123 may be fed into the Intelligent Evaluation System 133 to improve the evaluation process. The analysis employed in DCAU 123 may include, but is not limited to, analysis of text, image, sound, video, access requests, and any other data that may be transmitted via communication tools, methods and systems.

In one exemplary implementation, DCAU 123 may help improvement of the evaluation process by IES 133 as follows. A user 16 who works hard in an office may, because of some personal problems be suffering a very negative mood (detected by human state recognition 172) during a week. During the week, whenever the user 16 of this example tries to send a routine work report to his superior, a conventional system without a DCAU 123 module may trigger an unjustified warning about the user's negative mood. However, an implementation including DCAU 123 may be able to avoid such unnecessary warnings. Avoiding such unnecessary warnings may enhance the user experience and may avoid bothersome notifications.

DCAU 123 may optionally be equipped with profiling functionality to model the style of individual users (e.g. by learning the keywords that user 16 frequently employs in text data) so that DCAU 123 may better analyze the data content according to the user. A mathematical model based on pattern-recognition algorithms and statistical models may provide the profiling functionality. In some implementations, the mathematical model may be provided by a third party system. The mathematical model (optionally) may be adapted to the user 16 over time by learning (i) the style of interaction of the user 16 with the Data Transmission Application(s) 170 and (ii) the key content elements that the user employ in communications. An example of such pattern-recognition algorithms involves the generation of a bag of words on text contents, and employment of Gaussian mixture models for sentiment analysis.

DCAU 123 may optionally link to a memory component, User Specific Content Model (USCM) 124, where it may record the parameters for adapting the analysis according to the user 16. For example, the keywords of text, key frames of videos, key characteristics of images, sounds and other data that improves the content analysis for user 16 may be recorded in the memory component USCM 124.

A trigger evaluation operation 113 performed by IES 133 may be improved by considering the contextual information of the data transmission. The contextual information refers to the information regarding the environmental parameters and other factors that includes, with no limitations, climate conditions, the geographical positioning (from GPS), the time of the day, the date, the devices (and the vehicles) that person is using when a data transmission takes place, and any other relevant contextual information. Context Recognition Unit (CRU) 120 provides the contextual information to the IES 133. Contextual information may enhance the evaluation process within IES 133. For example, an angry user sending an email to his superior may be angry because he is stuck in traffic. Contextual information may include environmental noise from the traffic jam, and may provide the necessary contextual information for IES 133 to determine that the user is in a triggering state requiring only a warning instead of a complete transmission blockage IES 133 may, by default, block the email of an angry user to his superior, but, by using contextual information, IES 133 will warn the person with a notification instead of blocking the transmission. If IES 133 were to block the transmission based on the user's anger, it may result in a feedback loop wherein the user becomes angrier because they cannot send an e-mail that will not trigger negative consequences.

A trigger evaluation operation 113 performed by IES 133 maybe improved by considering a set of rules determined by the user in memory component User's Predefined Rules (UPR) 117. User 16 may specify a set of conditions on the available inputs to the IES 133 in comprehensive system 101 and may determine a method of evaluation to be employed by IES 133. For example, the user 16 may create the following rule (only based on human states): “When I am excited notify me to proof read the content of my email”. The following is another example (that considers human states as well as some other parameters): “If I am at my office and I am feeling very negative and I am sending an angry email to my colleague, do not send the email.” UPR database 117, with the help of natural language processing methods and tools may include sets of executable computer instructions to be employed within the IES 133. User 16 may optionally provide an importance/intensity indicator (e.g. a number between 0 and 1 where 1 indicates very important/intense) for each element of each rule, to be used (e.g., by fusion gate 131, discussed below) to enhance the evaluation process within IES 133.

A trigger evaluation operation 113 performed by IES 133 may be improved by considering user information about the user 16 that may be provided by Profiling Unit (PU) 125. Profiling Unit 125 may be equipped with a memory component Users' Profile Database (UPD) 126. PU 125 may access, in UPD 126, demographic information of user 16 including, but not limited to, gender, age, ethnicity, and personality type. PU 125 may additionally gain demographic or profiling information of a user via profiles of the user 16 on available networks such as social networks (e.g., Facebook). PU 125 may use the available information from (social) networks to infer subjective parameters and embed the subjective parameters of the user in user 16's profile that may be used for enhancing the evaluation process within IES 133. PU 125 may embed the information provided by third party applications/systems/methods that describe subjective parameters of user 16. UPD 126 may store the profile information of user 16, including but not limited to demographic information and subjective parameters.

PU 125 optionally may include learning functionality. PU 125 may learn additional user information based on (i) the interaction of the user 16 with the notification unit 174, (ii) the information provided by the user in the RIPU 122, and the UPR 117. The learning functionality of PU 125 may be provided by machine learning techniques and statistics that consider the inputs and the output of IES 133, and the inputs of the user within the notification unit 174 (e.g. via the selected option among options 56) to create rules that implicitly describe user preferences. The created rules by the learning functionality may be used in evaluation of the human state within the IES 133. UPD 126 may store the created rules and the UPD 126 may be updated by the learning functionality of the UPR 117 over time.

The IES 133 may optionally trigger an Action Unit (AU) 118. AU 118 may implement a set of consequent actions after triggering. Consequent actions may include actions in addition to transmission control of communicated data 40. For example, consequent actions may include sending information to another system, calling a person, opening/running an application, and/or sending a notification to another person. IES 133 may be in charge of triggering the AU 118. IES 133 may trigger an action unit 118 at any time, whether a data transmission has been initiated or not.

Notification unit 174 may notify a user of an intervention decision determined by IES 133. Notification unit 174 may further prompt a user for a decision and receive the decision in notification situations requiring it. Notification unit 174 may further provide information about a user's decision to data transmission application 36 for execution.

An example of an application of AU 118 may be as follows: a cashier at the bank is threatened and asked to give money to an individual. The stress level recognized may lock all the cashiers and send an alert to a higher authority in the bank or even the police.

Another example of an application of AU 118 may be as follows: a person feeling stressed (as human state) may send an email to his/her friend (as receiver information) at 2 am (as a part of the contextual information) from a location close to an insecure neighborhood (more contextual information provided by GPS). The combination of the human state data and complementary information may indicate that a crime is happening and the IES 133 may trigger AU 118 to warn local police officers.

FIG. 8 illustrates an example of an exemplary implementation of an IES 133 where the evaluation is mainly based the human state (provided by HSRU 172) of the user 16. As illustrated, IES 133 may include expert rule system 132 and fusion gate 131, and may interact with exemplary components and of IES 133 and components with which it may interact with human state recognition unit 172, action unit 118, and UPR 117. Expert Rule System (ERS) 132 may generate or embed rules for evaluation of input human states. ERS 132 may be a mathematic model with the possibility of featuring embedded memory capabilities to store “rule” information. ERS 132 may use different techniques including machine-learning, statistics, and fuzzy inference systems. The UPR 117 may provide the rules that are determined by user 16 and transformed in mathematical form (by the UPR 117) to IES 133 as input. IES 133 may be operable to combine or “fuse” the “rules” provided by the ERS 132 and the UPR 117 to perform the final evaluation on the human state (provided by HSRU 112) of the user 16. The fusion operation within IES 133 may take place at fusion gate 131. Fusion gate 131 may include a mathematic model with the possibility of featuring embedded memory capabilities to store information to leverage the rules provided by input components. Fusion gate 131 may use different techniques including machine-learning, statistics, and fuzzy inference systems. The output of fusion gate 131 may be a an evaluation of a triggering state of user 16, a determination that intervention is or is not required, and a level of intervention that is required. Fusion gate 131 may optionally trigger an Action Unit 118.

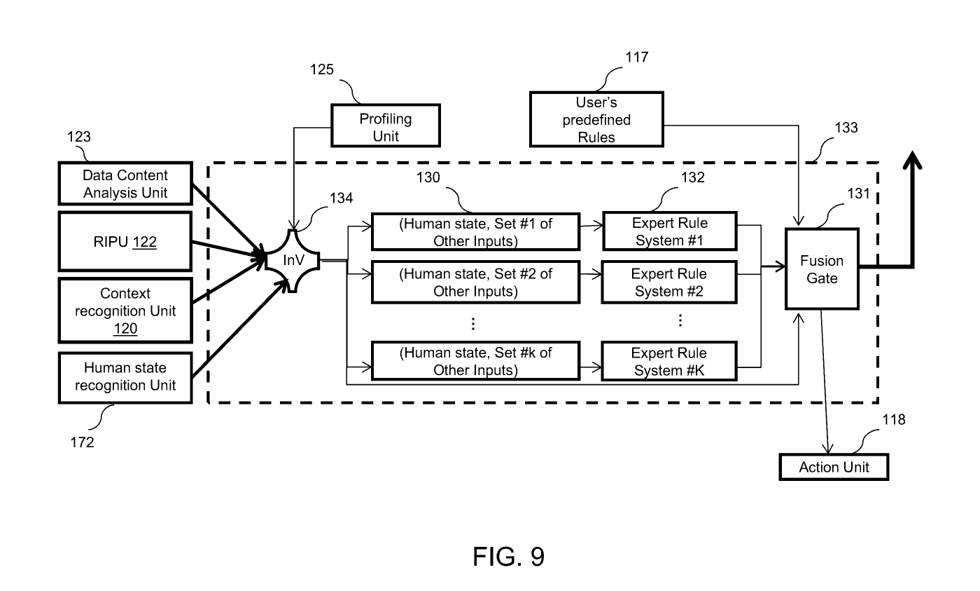

FIG. 9 illustrates an exemplary implementation of an IES 113 where evaluation is based on human state (provided by HSRU 172) of the user 16 and complementary data provided by additional components. As shown in FIG. 9, IES 133 may include a plurality of Expert Rule Systems (ERS) 132, fusion gate 131, and information valve (InV) 134. ERS 132 may generate and/or embed rules for evaluation of Input Sets 130. Input sets 130 may be created by information valve 134 as data sets containing any combination of all data available from CRU 120, RIPU 122, DCAU 123, PU 125, and HSRU 172. Input sets 130 may include of input data to the corresponding ERS 132, including the human state (provided by the HSRU 172) as well complementary data provided by one or more of DCAU 123, RIPU 122, PU 125, and CRU 120. The complementary data may be a subset of all possible input data, in this case example provided by CRU 120, RIPU 122, DCAU 123, PU 125. Each ERS 132 may include mathematic model with the possibility of featuring embedded memory capabilities to store trigger evaluation rule information. Each ERS 132 may use different techniques, including machine-learning, statistics, and fuzzy inference systems for creation of trigger evaluation rules. UPR 117 may provide user determined rules determined by user 16 and transformed in mathematical form (by the UPR 117) to IES 133 as input. IES 133 may be operable to combine or “fuse” the “rules” provided by the ERSs 132 and the UPR 117 to perform the final evaluation on the human state (provided by HSRU 172) of the user 16. The fusion operation within IES 133 may take place at fusion gate 131. Fusion gate 131 may include a mathematic model with the possibility of featuring embedded memory capabilities to store the information to leverage the rules provided by input components (via InV 134), ERSs 132, and the UPR 117. Fusion Gate 131 may use different techniques including machine-learning, statistics, and fuzzy inference systems for performing the evaluation. The output of fusion gate 131 may include an evaluation of a triggering state of user 16 and a subsequent decision on transmission control of the communicated data 40. A decision on transmission control may include triggering an intervention on data transmission and a determination of the type of intervention required. Fusion gate 131 may optionally trigger an Action Unit 118.

An exemplary implementation of the system 10 may occur as follows. A user may initiate an application 36 for the purpose of sending data, media, or any other element or message. The human state evaluation system 30 associated with or coupled to the application 36 may also be initiated at that time or may be running in the background. Human state evaluation system 30 may receive sensor data 32 such as that related to speech, brain activities (e.g. NIRS or EEG), Heart activities (e.g. ECG, BCP, Heart rate, PPG), electrodermal activity (GSR and Skin conductance), facial activities (e.g. facial action units, facial expressions and facial recognition), respiratory patterns, blood factors (e.g. blood oxygenation, glucose level, adrenaline intensity level, hormones' intensity levels), muscular activities (zygomatic, trapezius, corrugator), eye activities (gaze, blinks, blink rate, fixation, saccade), human gestures, human postures, human body pose, and/or any data that can be used for inference of human state in real-time or substantially real-time. Sensor data 32 may be used by human state recognition unit 172 to determine a human state of a user. Using the sensor data 32, the user's human states are determined to be in a triggering state based on the user's pre-defined rules or a known evaluation. For example, the user may write a message or select data to send using any e-mail provider, data transmission application or social media application and may select an option to send the message or data transfer. The transmission action may initiate a human state (e.g. emotion) evaluation. If the human state does not constitute a triggering state, the system 10 may allow the data transmission to occur transparently, i.e., without any further action by the user or notification of the user. If the human (emotional) state is determined to constitute a triggering state requiring intervention, system 10 may interrupt the transmission of the data and provides a notification, e.g., on-screen, to a wearable device or any other device or application, etc. The notification may be meant to allow the user to see his/her states (e.g. mental or emotional states), alert, and notify the user that he/she is sending an element with a triggering state in place, and may allow the user to control the transmission by the proposed actions, such as: cancel the transmission, edit or modify the transmission, save the transmission, proceed with the transmission, or any other action determined by the user. The system 10 may then proceed with the selected action.

System 10 may be used with any social network messaging such as Facebook, Twitter, LinkedIn, WhatsApp, Snapchat, Tumblr, etc. The system 10 may also be used with any mobile communication application such as text messaging, etc. The system 10 may be used with any e-mail provider (Hotmail, Gmail, Exchange, Outlook, etc). The system 10 may be linked to any existing or new human state recognition system or routine such as: emotions recognition or tracking from speech recognition, emotions recognition or tracking from facial recognition, emotions recognition or tracking from texts and words analysis, emotions recognition or tracking from biofeedback (HR, EEG, GSR, ST, etc.), emotions recognition or tracking from movement, posture or gesture analysis, emotions recognition or tracking from biochemical analysis, emotions recognition or tracking from any sensor or analysis, mental state recognition, human activity recognition from video camera, etc.

The system 10 may add only one step to the transmission process if the current human state is a triggering state requiring intervention, and may be transparent to the user if the emotion is not a triggering state requiring intervention. Another embodiment may prevent the user from transmitting any data if the triggering state is of sufficient severity. IES 133 may apply a rule with an output of triggering an intervention with a warning configuration similar to 60 as shown in FIG. 5 In another implementation, different levels of triggering states may that present and allows different options and possible actions so that IES 133 may apply a rule with an output of triggering an intervention with a warning configuration similar to 52, as shown in FIG. 4.

In another embodiment, the transmitted data may be an order to a market to buy, sell, or sell short, a financial instrument (common shares, preferred shares, bonds, options, certificates, contracts, derivatives, etc.).

In another embodiment, the system can block the access of the user's electronic access card (e.g. RFID for instance) or network access when a high level of stress is recognized. Such a system can be used in high-level security facilities. For example, in the Pentagon or CIA facility, the employees would not be able to open certain doors, or access sensible information or folders if their stress level is too high for security reasons. Stress can be related to threat or doing an illegal action.

In yet another embodiment system 10 may use context and a predefined user rule to operate a follows: the system may block the use of a credit card when the person is in a casino, after 2 am, with a high level of stress. The system 10 may employ a GPS and a mobile device to determine information about context and time.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10, any component of or related to the system 10, etc., or accessible or connectable thereto. Any application or module herein described may be implemented using computer readable/executable instructions that may be stored or otherwise held by such computer readable media.

The steps or operations in the flow charts and diagrams described herein exemplary only. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1) A system for controlling data transmissions based on a human state of a user, the system comprising:
at least one sensor configured to recognize personal data of the user indicative of the human state of the user;
at least one memory module;
a communications interface; and
a computer system comprising one or more physical processors programmed by computer program instructions that, when executed, cause the computer system to:
receive personal data of the user from the at least one sensor;
determine human state information according to the first personal data;
receive communication data intended composed by the user and intended for transmission;
identify complementary information based on the received communication data;
access the at least one memory module to obtain at least one trigger evaluation rule;
control transmission of the communication data via the communications interface according to the human state information and the complementary information.

2) The system according to claim 1, wherein the one or more physical processors are further programmed by computer program instructions to cause the computer system to identify complementary information based on a relationship between the user and an intended recipient of the communication data.

3) The system according to claim 1, wherein the one or more physical processors are further programmed by computer program instructions to cause the computer system to identify complementary information based on content of the communication data.

4) The system according to claim 1, wherein the one or more physical processors are further programmed by computer program instructions to cause the computer system to identify complementary information based on contextual information about at least one of a user's environment, a user's location, a time of day, and a device used by a user.

5) The system according to claim 1, wherein the one or more physical processors are further programmed by computer program instructions to cause the computer system to identify complementary information based on user profile data stored in the memory module.

6) The system according to claim 1, wherein the one or more physical processors are further programmed by computer program instructions to cause the computer system to display a user notification related to the transmission of the communication data.

7) The system according to claim 6, wherein the one or more physical processors are further programmed by computer program instructions to cause the computer system to:
receive a user response to the user notification, the user response indicating a choice of at least one of an option to save the communication data, modify the communication data, cancel the communication data, and send the communication data; and
control transmission of the communication data according to the user response.

8) The system according to claim 1, wherein the one or more physical processors are further programmed by computer program instructions to cause the computer system to control transmission of the communication data via the communications interface by blocking transmission of the communication data when a triggering state of the user according to the human state information and the complementary information exceeds a predefined threshold.

9) The system according to claim 1, wherein the one or more physical processors are further programmed by computer program instructions to cause the computer system to control transmission of the communication data via the communications interface by transparently allowing transmission of the communication data when a triggering state of the user according to the human state information and the complementary information does not exceed a predefined threshold.

10) The system according to claim 1, wherein the one or more physical processors are further programmed by computer program instructions to cause the computer system to trigger an action external to the computer system.

11) A computer implemented method for controlling data transmissions based on a human state of a user, the method comprising:
recognizing, via at least one sensor, personal data of the user indicative of the human state of the user;
receiving, by a computer system comprising one or more physical processors programmed by computer program instructions, personal data of the user from the at least one sensor;
determining, by the computer system, human state information according to the first personal data;
receiving, by the computer system, communication data intended composed by the user and intended for transmission;
identifying, by the computer system, complementary information based on the received communication data;
accessing, by the computer system, at least one memory module to obtain at least one trigger evaluation rule;
controlling, by the computer system, transmission of the communication data via a communications interface according to the human state information and the complementary information.

12) The method according to claim 11, further comprising identifying, by the computer system, complementary information based on a relationship between the user and an intended recipient of the communication data.

13) The method according to claim 11, further comprising identifying, by the computer system, complementary information based on content of the communication data.

14) The method according to claim 11, further comprising identifying, by the computer system, complementary information based on contextual information about at least one of a user's environment, a user's location, a time of day, and a device used by a user.

15) The method according to claim 11, further comprising identifying, by the computer system, complementary information based on user profile data stored in the memory module.

16) The method according to claim 11, further comprising displaying, by the computer system, a user notification related to the transmission of the communication data.

17) The method according to claim 16, further comprising:
receiving, by the computer system, a user response to the user notification, the user response indicating a choice of at least one of an option to save the communication data, modify the communication data, cancel the communication data, and send the communication data; and
controlling, by the computer system, transmission of the communication data according to the user response.

18) The method according to claim 11, further comprising controlling, by the computer system, transmission of the communication data via the communications interface by blocking transmission of the communication data when a triggering state of the user according to the human state information and the complementary information exceeds a predefined threshold.

19) The method according to claim 11, further comprising controlling, by the computer system, transmission of the communication data via the communications interface by transparently allowing transmission of the communication data when a triggering state of the user according to the human state information and the complementary information does not exceed a predefined threshold.

20) The method according to claim 11, further comprising triggering, by the computer system, an action external to the computer system.
